(19) United States
(12) Patent Application Publication
(10) Pub. No.: US 2007/0253290 A1
(43) Pub. Date: Nov. 1, 2007

(54) MODULAR WRISTWATCH

(76) Inventor: Christopher Aire, Los Angeles, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/740,702

(22) Filed: Apr. 26, 2007

Related U.S. Application Data
(60) Provisional application No. 60/767,507, filed on Apr. 27, 2006.

(51) Int. Cl. G04B 39/00

(52) U.S. Cl. 368/294

(57) ABSTRACT

A modular wristwatch includes a watch case assembly and a removable watch movement assembly. The watch case assembly includes an articulating bezel having a first bezel portion pivotally connected to a second bezel portion that enables the first bezel portion to move between open and closed configurations, allowing the watch movement assembly to be moved into and out from the watch case assembly.

### BACKGROUND OF THE INVENTION

The present invention relates generally to timepieces. More particularly, the present invention relates to a modular wristwatch having an articulating bezel permitting the removable insertion of a watch movement assembly into a watch case assembly thereof.

Wristwatches come in a variety of types including, but not limited to, mechanical windup watches, self-winding or “automatic” mechanical watches, electric or electronic (i.e., battery-powered) analog watches, battery-powered wristwatches with digital time displays (LED (light emitting diode) and constant-display LCD (liquid crystal display)) and analog quartz timing devices.

Wristwatches serve both utilitarian and decorative purposes. A wristwatch has become more than just a tool used to measure the passing of time. A wristwatch also serves as a decorative accessory; a blending of fashion and technology. Typically, a wristwatch has a number of elements including, but not limited to, a watch case having an integral housing, a bezel (e.g., a numbered and often rotatable dial on top of the watch case), a watch dial or movement contained within the watch case having a watch face, an hour hand, a minute hand and a second hand that indicate the time of day (or an electronic display indicating the time), and a watch band or strap. Each visible wristwatch element contributes to the overall decorative nature of the wristwatch, with the main design elements being the watch case, the watch dial, the bezel and the band. Many high-end watches are extremely expensive because they are made to be as decorative as they are functional. For example, a high-end watch may be made with a solid gold case encrusted with gem stones on the bezel or even on the watch face itself where gem stones are used to form hour numbers on the watch face. The watch face may also be decorated with a variety of colors and designs. The fashion nature of the wristwatch has created watches where the bezel, the case and/or the band have decorative features which allow a wearer to accentuate the outfit he or she is wearing. The manner in which a wristwatch can be decorated is limited only by the imagination.

In the past, since most watches were purchased in a fully assembled condition, the only way a wearer could select a watch to match an outfit he or she intended to wear was to select the watch based on the color of the watch case and/or the watch band. Today, various elements of the wristwatch can be switched out to suit the needs of the wearer. For example, watch bands have long been considered as decorative accessories and have been made interchangeable so that a wearer can detach a black watch band from the watch case and replace the black watch band with a band of another color (e.g., brown, white, blue, red, etc.).

Even the watch bezel, traditionally serving to retain the watch movement within the watch case, has become an interchangeable decorative element. For example, U.S. Pat. No. 4,462,697 discloses an integral plastic strap and bezel for a wristwatch which comprises a watch having a case element, which includes the watch movement and face, and a separate replaceable one-piece bezel and band element. However, while the bezel/band element can be changed in order to color coordinate the watch to the wearer's outfit, the watch case is a separate element that must be attached or connected to or held by the bezel/band element before the watch can be worn each time, usually by force-fitting the watch case into position within a recess of the bezel/band element or by snapping or fastening the watch case into the bezel/band. This can result in the watch case accidentally popping out from the bezel/band or otherwise becoming disengaged from the bezel/band if the wearer inadvertently jars the watch. In another example, U.S. Pat. No. 5,490,123 discloses a watch case exhibiting a detachable bezel. However, a disadvantage of such watches is that the bezel can become detached and lost.

While wristwatches such as those described above have enabled wristwatch wearers to modify the exterior of the wristwatch, there is still room for improvement. For example, the ability of a wristwatch wearer to modify the look of the watch face by allowing the wearer to switch out one watch movement with a particular face design for another watch movement with a different watch face design is desirable from a decorative standpoint. Another example of improvement would be the ability to streamline the look of the watch case since many wristwatches include a crown or knob of a watch stem connected to the watch movement. The knob of the watch stem typically extends outwardly from a rim of the watch case and the knob is capable of being partially withdrawn and turned and adjusted in order to adjust time indicating elements of the watch movement for display of the correct time. The knob, however, can detract from the symmetry and smooth lines of the watch case.

Accordingly, there is a need for a watch case that allows a wristwatch wearer to switch out watch movements. There is a further need for a watch case that streamlines the look of the watch case by concealing the knob(s) extending from the watch movement. The present invention fulfills these needs and provides other related advantages.

### SUMMARY OF THE INVENTION

The present invention resides in a modular wristwatch. The modular wristwatch generally comprises a watch case assembly including an articulating bezel having a first bezel portion pivotally connected to a second bezel portion. The first bezel portion is removable between an open configuration and a closed configuration. A watch movement assembly is removably insertable into the watch case assembly when the first bezel portion of the articulating bezel is in the open configuration. The watch movement assembly is retained within the watch case assembly when the first bezel portion is in the closed configuration.

Typically, the watch case assembly also includes a back plate disposed below the articulating bezel. The back plate and the second bezel portion of the articulating bezel, which is usually stationary or fixed, cooperatively form a watch movement assembly receiving slot.

The watch case assembly preferably includes an aperture formed between a truncated edge of the back plate and the bezel. This enables control knobs of the watch movement assembly to be accessed through the watch case assembly aperture. The watch movement assembly typically also includes a housing substantially enclosing a watch face or display. A watch crystal is typically disposed above the watch face or display.

Means are provided for selectively locking the first bezel portion of the articulating bezel in the closed configuration. In one embodiment, a wrist band lug is pivotally connected to the watch case assembly, and movable between an open configuration away from the watch case assembly and a closed configuration locking the first bezel portion in the closed configuration. A locking mechanism is operably associated with the wrist band lug and the articulating bezel. For example, the locking mechanism may comprise latches extending from the wrist band lug and insertable into corresponding recesses of the first and second bezel portions of the articulating bezel. The latches are biased into a locking position within the recesses, but selectively movable into an unlocked position.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a watch case with an articulating bezel of the present invention, holding a watch movement assembly;

FIG. 2 illustrates the watch case of FIG. 1 with the bezel in a closed configuration, further showing where force is applied to unlock the bezel;

FIG. 3 is a view similar to FIG. 2, illustrating the bezel in an open configuration, with the watch movement assembly partially removed from the watch case;

FIG. 4 is a perspective view similar to FIG. 3, illustrating the watch movement being moved in and out of the watch case;

FIG. 5 is a perspective view, similar to FIG. 4, illustrating only the watch case with the bezel in the open configuration;

FIG. 6 is a top plan view of the watch case of FIGS. 1-5, illustrating band lugs thereof in a closed and locked configuration;

FIG. 7 is a bottom plan view of the watch case of FIGS. 1-6;

FIG. 8 is a side elevation view of the watch case of FIGS. 1-7;

FIG. 9 is a fragmented, enlarged sectional view of area 9 of FIG. 6, illustrating a bezel locking mechanism in a closed configuration;

FIG. 10 is a fragmented, enlarged sectional view of area 9 of FIG. 6, illustrating the bezel locking mechanism in an open configuration;

FIG. 11 is a top plan view similar to FIG. 6, illustrating the band lugs in an open configuration;

FIG. 12 is a side elevation view, taken along line 12-12 of FIG. 11;

FIG. 13 is a side elevation, taken along line 13-13 of FIG. 11; and

FIG. 14 is a side elevation view, taken along line 14-14 of FIG. 4, illustrating the watch movement being moved in and out of the watch case.

### DETAILED DESCRIPTION OF THE PREFERRED EMBODIMENTS

As shown in the accompanying drawings for purpose of illustration, the present invention resides in a modular wristwatch, generally referred to by the reference number 20. By way of illustration, the modular wristwatch 20 is depicted as being of an analog, chronometer type with four function dials including, without limitation, a stopwatch function, an illumination function or the like. However, the present invention is equally applicable to a single function analog wristwatch, a single or multi-functional digital wristwatch or a combination analog and digital wristwatch.

The modular wristwatch 20 includes a watch case assembly 30, a watch movement assembly 40 removably disposed within the watch case assembly 30, and a watch strap 50 detachably connected to the watch case assembly 30.

The watch case assembly 30 includes a housing 32 formed by a back plate 34 with a truncated edge 35, and an articulating bezel 38. A pair of wrist band lugs 38 is pivotally connected to opposite sides of the housing 32 to enable attachment of the watch band or strap 50 to the housing 32. Each wrist band lug 38 is connected by a hinge (not shown for clarity) to the watch case assembly 30, typically to the back plate 34. The watch strap 50 is connected to the pair of wrist band lugs 38 in a conventional manner. The watch strap 50 may be various types including, but not limited to, a leather strap, a plastic strap, a metal strap or a combination of the aforementioned types of straps. The housing 32 may be made from a variety of materials including, but not limited to, aluminum, gold (plated or solid), platinum (plated or solid), stainless steel, silver, plastic or the like. In the alternative, gem stones may be embedded on the surface of the housing 32.

The watch movement assembly 40 includes a self-contained, sealed housing 42 within which a truncated annular watch movement 44 having a watch face or dial 46 is disposed. The housing 42 is sized and shaped in a manner similar to, but smaller than, the circular back plate 34 with the truncated edge 35 in order for the housing 42 to fit within the watch case assembly 30. When the watch movement assembly 40 is disposed within the watch case assembly 40, the truncated edge 35 of the back plate 34 is generally aligned with a truncated side/edge 43 of the housing 42. A watch crystal 48, preferably made from a scratch-resistant mineral glass, is positioned over the watch movement 44.

In the illustrated embodiment, several watch movement control knobs 52 extend through a side wall of the housing 42. These knobs 52 are connected to the watch movement 44 such as through stems (not shown) extending through the housing to manipulate gears or other internal mechanisms as is well known in the art. The knobs 52 are capable of being partially withdrawn and turned and adjusted in order to adjust the time indicating elements of the watch movement 44 for display of the correct time as well as to activate the functions of the dials 54, 56, 58, 60. Also associated with the watch face 18 are hour and minute hands 57 and 59 (shown in phantom) operationally connected to the watch movement 44. In the alternative, a second hand may also be present. The hour, minute and second hands may be made from metal and covered with a decorative fluorescent coating to enable the hour, minute and second hands to glow-in-the-dark. The housing 42 may be made from a variety of materials including, but not limited to, aluminum, gold (plated or solid), platinum (plated or solid), stainless steel, silver, plastic or the like. In the alternative, gem stones may be embedded on the surface of the watch face 46.

In the illustrated embodiment, the watch face 46 includes first, second, third and fourth small, calibrated dials 54, 56, 58, 60. No dial hands are shown associated with respective dials 54, 56, 58, 60 for reasons of clarity but the hands would be connected to the watch movement 44 by respective drive pins to display tenths of seconds, seconds, minutes or the like depending on the function desired to be displayed. Alternatively, dials displaying a day of the week, month, and day of the month, may also be disposed on the watch face 46. The dial hands may be made from metal and covered with a decorative fluorescent coating to enable the dial hands to glow-in-the-dark.

The watch face 46, regardless of configuration, may be made from any thin, suitable material and may be finished in any desired manner. For example, the watch face 46 may include a black face with white dials 54, 56, 58, 60 and white hour and minute hands. Alternatively, the previously described color scheme may be reversed or other color schemes may be used to provide a contrast between the watch face 46 and the dials 54, 56, 58, 60 and the minute and second hands. Likewise, the watch face 46 may include a color scheme to complement that of the bezel 36.

Although a watch movement 44 has been described in detail above for illustrative purposes, it will be understood that the watch movement 44 may be any existing type, with the watch face 46 adapted for that particular type, including, but not limited to a mechanical type (either automatic (self winding) or a wind-up type), a digital display type, a quartz electronic display type, or any other available type.

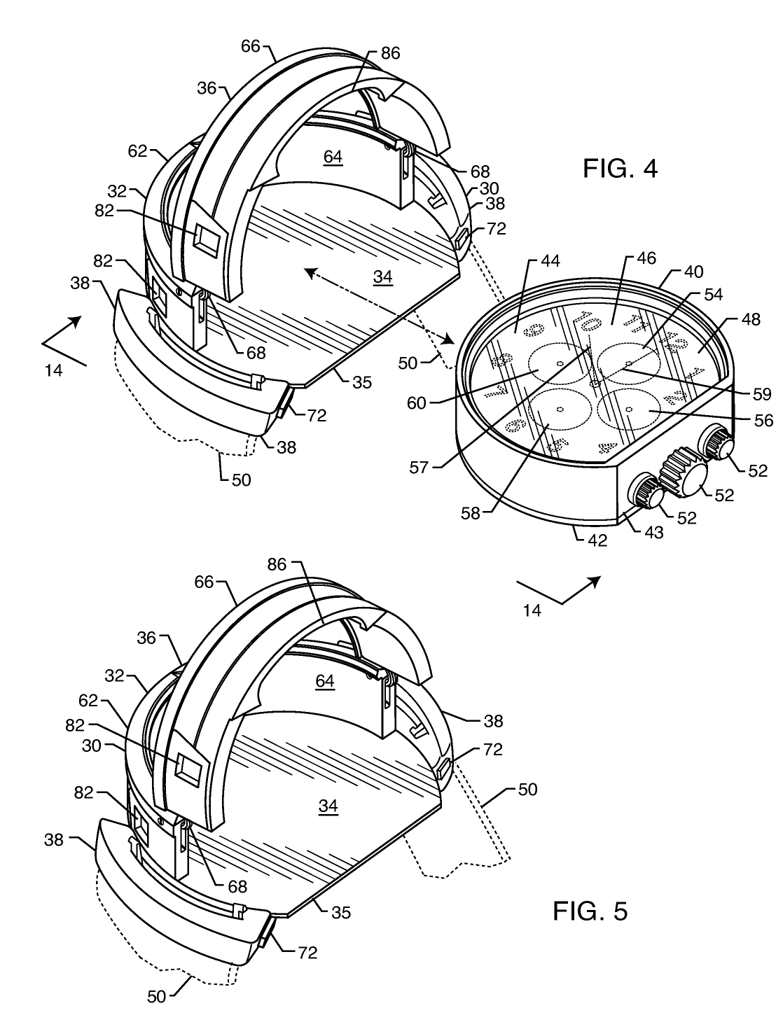

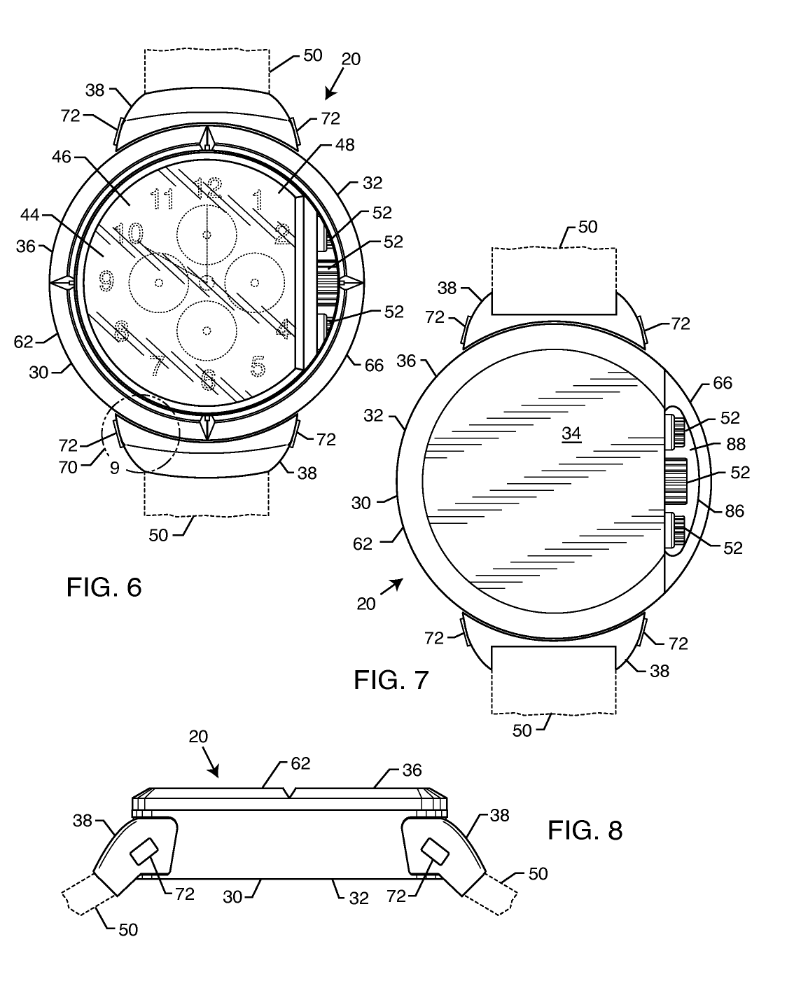

The bezel 36 comprises a first bezel portion 66 pivotally connected to a second bezel portion 62, such as by recessed hinges 68. Typically, the second bezel portion 62 is stationary or fixed, such as attached to the back plate 34, so as to define a slot 64 into which the watch movement assembly 40 can be inserted when the first bezel portion 66 is moved to an open configuration, as illustrated in FIGS. 4 and 5.

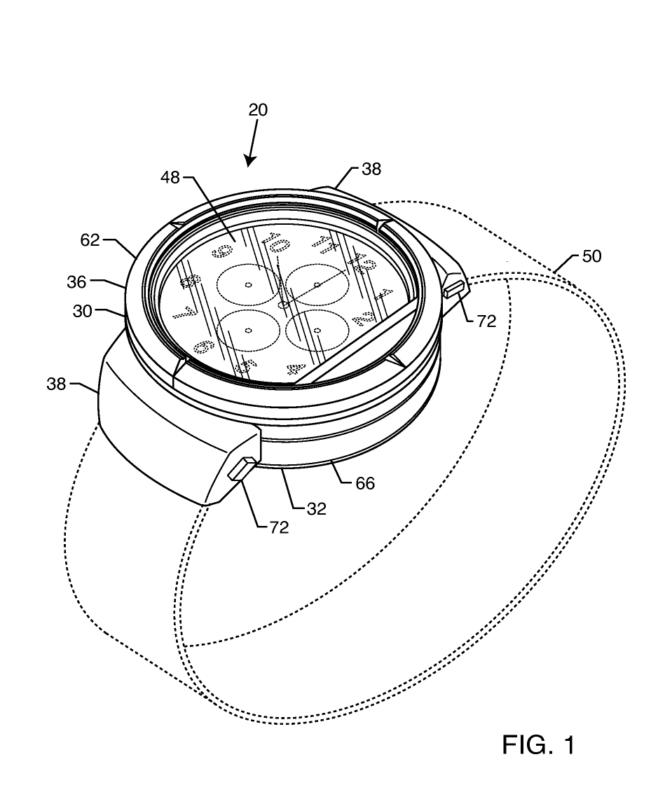

Means are provided for locking the first pivoting bezel portion 66 into its closed configuration, as illustrated in FIG. 1. In a particularly preferred embodiment, a pair of locking mechanisms 70 on each wrist band lug 38 is used to secure the pivoting bezel portion 66 in the closed configuration. The stationary and pivoting bezel portions 62, 66 may be decorated with gems stones or unadorned with a color that of the material from which the stationary and pivoting bezel portions 62, 66 are made or the color of the material plated to the surface of the stationary and pivoting bezel portions 62, 66.

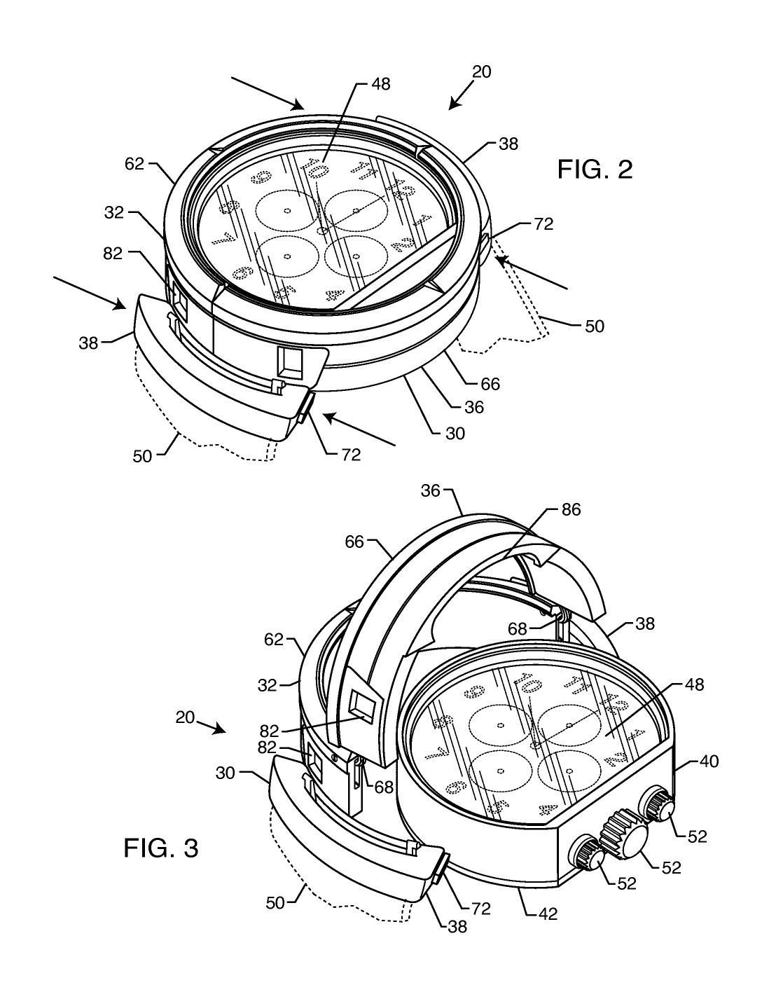

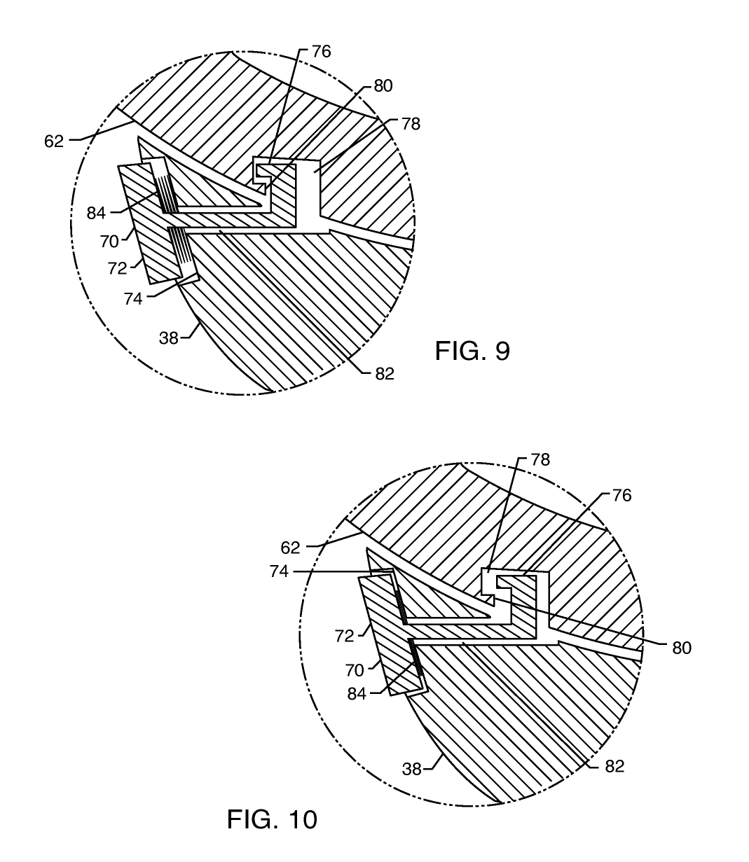

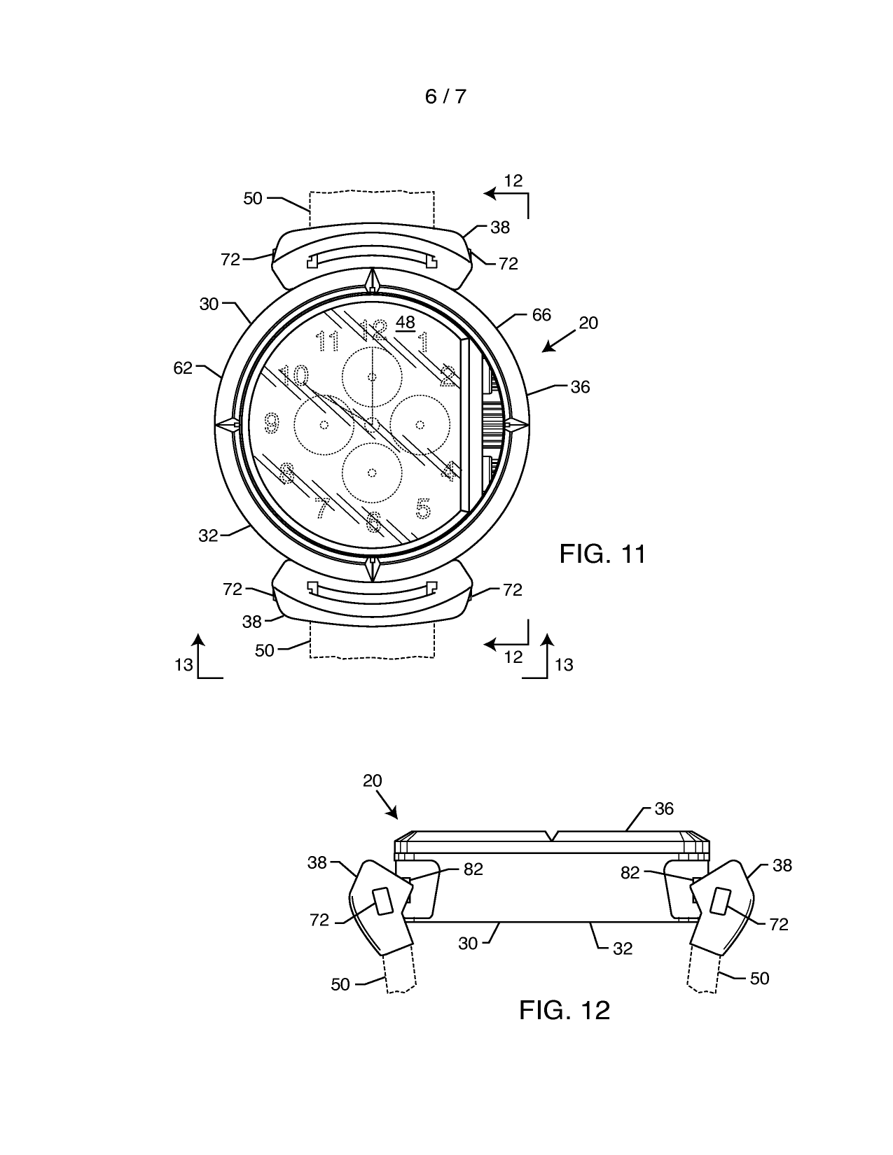

In operation, an individual user may desire to change the style of the watch face or display 46 of their wristwatch 20. As seen in FIGS. 2, 9 and 10, the user merely depresses protrusions 72 of the locking mechanisms 70 that extend outwardly from respective recesses 74 within respective wrist band lugs 38 (arrows of FIG. 2 indicating the direction in which pressure is applied by the user). Each protrusion 72 is connected to a latch 76 extending through a channel 82 formed in each respective lug 38 and into a respective recess 78 of the stationary and pivoting bezel portions 62, 66. Each latch 76 engages a respective flange 80 extending partially into the recess 78. A spring 84 is disposed between each protrusion 72 and the back of its respective recess 74 of the wrist band lug 38, which serves to spring-load or bias the latches 76 into engagement with flange 80 The spring 84, which has been compressed by the user depressing the protrusion 72, automatically pushes the protrusion 72 outwardly, which in turn moves the latch 76 away from its engagement with the flange 80 if the latch 76 is still disposed within the recess 78.

Once the latch 76 is disengaged from the flange 80, the lug 38 is rotated away from the housing 32 to an open configuration from the closed configuration, which in turn moves the latch 76 out of the recess 78. Once each latch 74 has been removed from its respective recess 78, the pivoting bezel portion 66 can be moved into the open configuration, as seen in FIG. 14.

Once the pivoting bezel portion 66 has been moved into the open configuration, the watch movement assembly 40 may be moved out of the slot 64 of the housing 32 of the watch case assembly 30 and moved back into the slot 64 of the housing 32 once a new battery (not shown) within the watch movement assembly 40 has been replaced the rundown battery. In the alternative, once the old watch movement assembly 40 has been moved out of the housing 32, another watch movement assembly 40 with a different watch face or display 46 may be moved into the housing 32 by sliding the watch movement assembly 40 into the slot 64 of the housing 32. FIGS. 4 and 14 illustrate movement of the watch movement assembly into and out of the watch case assembly 30.

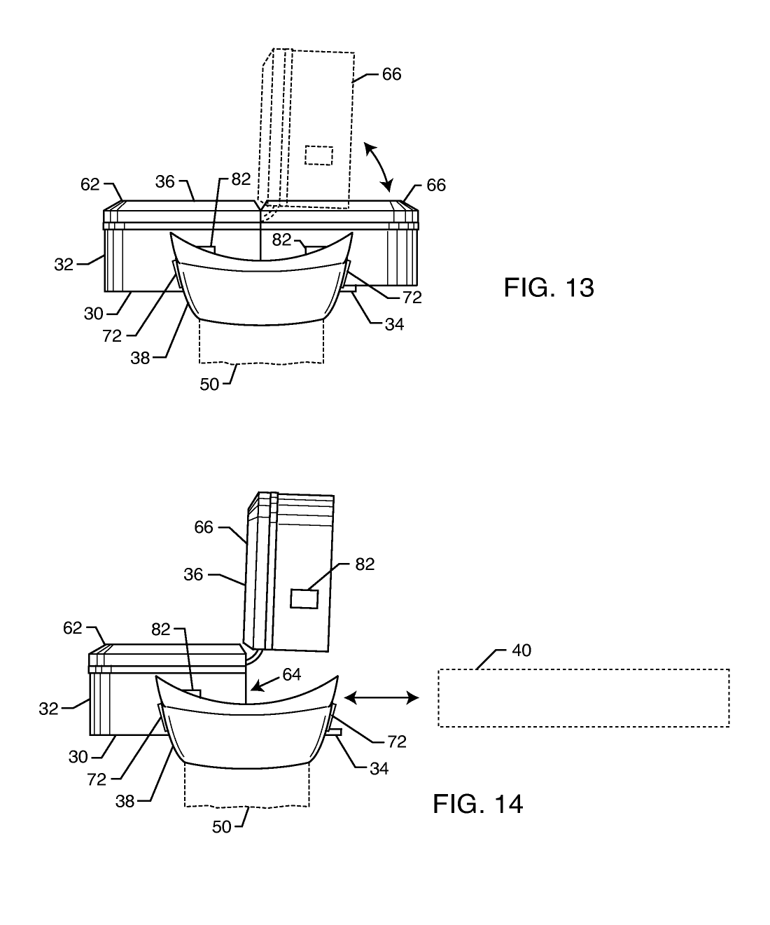

When the user desires to return the pivoting bezel portion 66 to the closed configuration, the user rotates the bezel portion 66 to the closed configuration, once again depresses the protrusions 72 (as seen in FIG. 2) while the lugs 38 are still rotated away from the housing 32 in the open configuration and then rotates the lugs 38 back into the closed configuration (while the spring-laden protrusions 72 are still depressed in order to position the latches 76 within the recesses 78 in order to engage each latch 76 with its respective flange 80) which once again locks the pivoting bezel portion 66 in the closed configuration. Movement of the pivoting bezel portion 66 between the open and closed configurations is illustrated in FIG. 13.

As seen in FIG. 3, a partially annular, inner lip 86 of the rotating bezel portion 66 is shaped to permit the first bezel portion 66 to move between the open and closed configurations without contacting the knobs 52. When the bezel portion 66 is in the closed configuration, the ends of the knobs 52 of the watch movement assembly 40 are covered by the bezel portion 66 but while still providing the user with the ability to access the knobs 52, as seen in FIG. 8, due to the truncated edge of the circular back plate 34 forming an aperture 88 with the inner lip 86 of the rotating bezel portion 66 that provides access to the knobs 52 of the watch movement assembly 40. The aperture 88 allows a user to access the knobs 52 in order to adjust the time displayed by the watch movement assembly 40 and/or access a function performed by one or more of the knobs 52.

Although several embodiments have been described in detail for purposes of illustration, various modifications may be made without departing from the scope and spirit of the invention. Accordingly, the invention is not to be limited, except as by the appended claims.

What is claimed is:

1. A modular wristwatch, comprising:
a watch case assembly including an articulating bezel having a first bezel portion pivotally connected to a second bezel portion, the first bezel portion movable between an open configuration and a closed configuration; and
a watch movement assembly removably insertable into the watch case assembly when the first bezel portion of the articulating bezel is in the open configuration, and retained within the watch case assembly when the first bezel portion is in the closed configuration.

2. The modular wristwatch of claim 1, wherein the watch case assembly includes a back plate disposed below the articulating bezel.

3. The modular wristwatch of claim 2, wherein the back plate and the second bezel portion of the articulating bezel cooperatively form a watch movement assembly receiving slot.

4. The modular wristwatch of claim 2, wherein the watch case assembly includes an aperture between a truncated edge of the back plate and the bezel.

5. The modular wristwatch of claim 4, wherein the watch movement assembly includes a housing substantially enclosing a watch face or display, and control knobs extending from the housing and accessible through the watch case assembly aperture.

6. The modular wristwatch of claim 5, wherein the housing includes a watch crystal disposed above the watch face or display.

7. The modular wristwatch of claim 1, including means for selectively locking the first bezel portion of the articulating bezel in the closed configuration.

8. The modular wristwatch of claim 1, including a wrist band lug pivotally connected to the watch case assembly and movable between an open configuration away from the watch case assembly and a closed configuration locking the first bezel portion in the closed configuration.

9. The modular wristwatch of claim 8, including a locking mechanism operably associated with the wrist band lug and the articulating bezel.

10. The modular wristwatch of claim 9, wherein the locking mechanism comprises latches extending from the wrist band lug and insertable into corresponding recesses of the first and second bezel portions of the articulating bezel.

11. The modular wristwatch of claim 10, wherein the latches are biased into a locking position within the recesses, and selectively movable into an unlocked position.

12. A modular wristwatch, comprising:
a watch case assembly including an articulating bezel movable between an open and a closed configuration;
a watch movement assembly removably insertable into the watch case assembly when the articulating bezel is in the open configuration, and retained within the watch case assembly when the articulating bezel is in the closed configuration; and
a wrist band lug pivotally connected to the watch case assembly and movable between an open configuration away from the watch case assembly and a closed configuration locking the articulating bezel in the closed configuration.

13. The modular wristwatch of claim 12, wherein the articulating bezel includes a first bezel portion pivotally connected to a second bezel portion, the first bezel portion movable between the open and closed configurations.

14. The modular wristwatch of claim 13, wherein the watch case assembly includes a back plate disposed below the articulating bezel, the back plate and the second bezel portion cooperatively forming a watch movement assembly receiving slot.

15. The modular wristwatch of claim 14, wherein the watch case assembly includes an aperture between a truncated edge of the back plate and the articulating bezel.

16. The modular wristwatch of claim 15, wherein the watch movement assembly includes a housing substantially enclosing a watch face or display, and control knobs extending from the housing and accessible through the watch case assembly aperture.

17. The modular wristwatch of claim 16, wherein the housing includes a watch crystal disposed above the watch face or display.

18. The modular wristwatch of claim 13, including a locking mechanism operably associated with the wrist band lug and the articulating bezel.

19. The modular wristwatch of claim 18, wherein the locking mechanism comprises latches extending from the wrist band lug and insertable into corresponding recesses of the first and second bezel portions of the articulating bezel.

20. The modular wristwatch of claim 19, wherein the latches are biased into a locking position within the recesses, and selectively movable into an unlocked position.
